(19) United States
(12) Patent Application Publication
(10) Pub. No.: US 2026/0073141 A1
(43) Pub. Date: Mar. 12, 2026

(54) INPUT SUPPORT APPARATUS, METHOD, AND STORAGE MEDIUM

(71) Applicant: KABUSHIKI KAISHA TOSHIBA, Kawasaki-shi (JP)

(72) Inventors: Kosei FUME, Kawasaki Kanagawa (JP); Shintaro HARADA, Yokohama Kanagawa (JP)

(73) Assignee: KABUSHIKI KAISHA TOSHIBA, Kawasaki-shi (JP)

(21) Appl. No.: 19/299,832

(22) Filed: Aug. 14, 2025

(30) Foreign Application Priority Data
Sep. 11, 2024 (JP) 2024-157587

(51) Int. Cl. G06F 40/284; G06F 40/268

(52) U.S. Cl. CPC G06F 40/284; G06F 40/268

(57) ABSTRACT

An input support apparatus includes processing circuitry configured to detect a division position in input data and divides the input data into a plurality of division units, acquire an estimation code by estimating a classification code of the input data by using a classification model that receives an input of data and estimates the classification code in a classification system, classify the classification code into a plurality of clusters using explanatory information of the classification code and constructs a cluster space by embedded expression, calculate a cluster similarity between the input data and the cluster by using the cluster space, and adjust a method of outputting the estimation code based on the cluster similarity.

### CROSS-REFERENCE TO RELATED APPLICATIONS

This application is based upon and claims the benefit of priority from Japanese Patent Application No. 2024-157587, filed Sep. 11, 2024, the entire contents of which are incorporated herein by reference.

### FIELD

Embodiments described herein relate generally to an input support apparatus, a method, and a storage medium.

### BACKGROUND

An automatic classification function that automatically estimates a classification of input data of a document or the like and outputs a classification code is known. The classification code includes a number, a symbol, a character string, and the like. In the automatic classification function, for example, a machine learning model (hereinafter, referred to as an estimation model) trained to receive an input of the document, estimate the classification code of a target classification system, and output the estimated classification code is used. Hereinafter, the classification code output by the estimation model is referred to as an estimation code.

A processing method in the automatic classification can be divided into a batch processing method and a sequential processing method according to a method of inputting the input data and timing of outputting the estimation result. The batch processing method is a method of inputting an entire input document at a time, collectively processing content of the input document, and outputting the classification code. The sequential processing method is a method of outputting the classification code estimated using input data at that time as needed during input of the input document by a user.

Further, an input support apparatus using the automatic classification function of the sequential processing method as a user's input support means is known. The input support apparatus displays the estimation code in conjunction with an input of a character string of the user. By interactively changing the input while checking the estimation code in the middle of input, the user can make an intended input to an automatic classification system, and can appropriately change input content while viewing a reaction of the system.

In such an input support apparatus, in a case where the displayed classification code is different from user's intuition or intention, usability is significantly reduced, and value of the automatic classification system may be reduced. For example, an input support apparatus that supports creation of a failure report document automatically estimates an industry-predetermined failure code number from hundreds of candidates and presents an estimation result to the user every time a character string is input by the user. In such an input support apparatus, since an input unit and speed of the user are not considered, the displayed estimation code may change every time one character is input. In this case, since output information changes quickly for the user, a code that does not conform to the intuition of the user and does not satisfy the user may be output.

### BRIEF DESCRIPTION OF DRAWINGS

FIG. 1 is a diagram illustrating an example of a configuration of an input support apparatus.

FIG. 2 is a flowchart illustrating a processing procedure of pre-processing by the input support apparatus.

FIG. 3 is a diagram illustrating an example of classification codes.

FIG. 4 is a diagram illustrating an example of an extraction result of vocabularies in FIG. 3.

FIG. 5 is a diagram illustrating an example of clusters constructed using the vocabularies of FIG. 4.

FIG. 6 is a flowchart illustrating a processing procedure of input support processing by the input support apparatus.

FIG. 7 is a diagram illustrating an example of an input screen.

FIG. 8 is a diagram illustrating an example of a calculation result in the input support processing.

FIG. 9 is a flowchart illustrating a processing procedure of output balancing processing by the input support apparatus.

FIG. 10 is a diagram illustrating an example of the input screen.

FIG. 11 is a diagram illustrating an example of the input screen.

FIG. 12 is a diagram illustrating an example of the input screen.

FIG. 13 is a diagram illustrating an example of the input screen.

FIG. 14 is a diagram illustrating an example of a configuration of an input support apparatus according to an application.

### DETAILED DESCRIPTION

In general, according to one embodiment, an input support apparatus includes processing circuitry. The processing circuitry is configured to detect a division position in input data and divides the input data into a plurality of division units, acquire an estimation code by estimating a classification code of the input data by using a classification model that receives an input of data and estimates the classification code in a classification system, classify the classification code into a plurality of clusters using explanatory information of the classification code and constructs a cluster space by embedded expression, calculate a cluster similarity between the input data and the cluster by using the cluster space, and adjust a method of outputting the estimation code based on the cluster similarity.

Hereinafter, an input support apparatus, a method, and a storage medium according to an embodiment will be described with reference to the drawings.

### First Embodiment

FIG. 1 is a diagram illustrating a configuration example of an input support apparatus 100. The input support apparatus 100 is an apparatus that automatically classifies data using a sequential processing method and supports user's input. The input support apparatus 100 is connected to an input unit to which a user inputs input data and a display unit that displays a classification code for the input data via a network or the like. The network is, for example, a local area network (LAN). Note that the connection to the network may be a wired connection or a wireless connection. Furthermore, the network is not limited to the LAN, and may be the Internet, a public communication line, or the like.

The input support apparatus 100 sequentially acquires the input data input by the input unit, inputs the acquired input data to an estimation model, and presents a classification result output from the estimation model to the user via the display unit. Further, the input support apparatus 100 adjusts the method of displaying the estimation result in consideration of accuracy and change of the estimation result of the automatic classification with respect to the sequential input. For example, the input support apparatus 100 is an apparatus that estimates and displays the classification code at the time of creating an anomaly report of a machine or a system.

The input data is data input by the user. The input data is, for example, a text data or image data group including sequence information. In the present embodiment, a case where an input sentence of text data is used as input data will be described as an example. The user inputs the input sentence in units of character strings, morphemes, sentences, or the like by operating an input interface such as a keyboard. The input support apparatus 100 adjusts displaying of an estimation code by using a clause delimiter or a grammatical structure delimiter as a clue. Further, the input support apparatus 100 constructs a vocabulary space by using explanatory information regarding the classification system of classification targets. It adjusts variability of the estimation code to be displayed by using similarity between a cluster in the vocabulary space and the input sentence.

The input support apparatus 100 includes a processing circuitry that control the entire input support apparatus 100 and a storage medium (memory). The processing circuitry is a processor that executes functions of an input detection unit 101, a code estimation unit 102, a cluster space construction unit 103, a cluster space search unit 104, and an output balancing unit 105 by calling and executing a program in the storage medium. The processing circuitry includes an integrated circuit including a central processing unit (CPU), an application specific integrated circuit (ASIC), a field programmable gate array (FPGA), and the like. The processor may be formed from one integrated circuit, or may be formed from a plurality of integrated circuits.

The storage medium stores a processing program used in the processor, parameters and tables used in calculation in the processor, and the like. The storage medium is a storage apparatus such as a hard disk drive (HDD), a solid state drive (SSD), or an integrated circuit that stores various types of information. Further, the storage apparatus may be a portable storage medium such as a compact disc (CD), a digital versatile disc (DVD), or a flash memory, or may be a drive apparatus that reads and writes various types of information from and to a semiconductor memory element such as a flash memory or a random access memory (RAM), in addition to the HDD, the SSD, or the like.

Note that the functions of the input detection unit 101, the code estimation unit 102, the cluster space construction unit 103, the cluster space search unit 104, and the output balancing unit 105 may be implemented by a single processing circuitry, or may be implemented by combining a plurality of independent processors to configure the processing circuitry and executing the program by each processor. Further, the functions of the input detection unit 101, the code estimation unit 102, the cluster space construction unit 103, the cluster space search unit 104, and the output balancing unit 105 may be implemented as individual hardware circuits.

The input detection unit 101 acquires the input data input by the user, detects a division position in the input data, and divides the input data into a plurality of division units. For example, the input detection unit 101 receives the input sentence input by the user, detects a morpheme delimiter in the input sentence, and divides the input sentence into a plurality of division units using the morpheme delimiter. The division unit is, for example, a token. Hereinafter, the division unit is referred to as a token. A token may be referred to as a vocabulary or morpheme. For example, the input detection unit 101 detects the morpheme delimiter by performing a morpheme analysis for the input sentence, and divides the input sentence into a plurality of tokens using the morpheme delimiter. In addition, the input detection unit 101 analyzes a part of speech of each token by the morpheme analysis.

Further, the input detection unit 101 detects a syntax delimiter by executing syntactic analysis for the input sentence, weights each token according to the syntax delimiter, and determines a weight value (hereinafter referred to as a boundary weight) of each token. The syntax delimiter is a delimiter of a syntactical meaning in the input sentence. For example, the input detection unit 101 detects a punctuation mark or the last token among a series of tokens in which a part of speech has undergone a specific change as the syntax delimiter.

Thereafter, the input detection unit 101 sets the boundary weight of each token according to a predetermined condition regarding the syntax delimiter. For example, in a case where the token is a punctuation mark, or in a case where the immediately preceding token is a noun and a boundary token is a particle, the boundary weight is made larger than that in other cases. Further, the weighting may be performed according to a statistic. As the statistic, for example, an appearance frequency of a part of speech in the input sentence can be used. In this case, the boundary weight may be made larger in a case where the appearance frequency is small than that in other cases. Further, syntactical classification of each token may be analyzed by the syntactic analysis, and the appearance frequency of the classification in the input sentence may be used as the statistic. Further, the boundary weight may be corrected according to the number of characters or the number of tokens of the input sentence up to the target token.

The code estimation unit 102 acquires the estimation code obtained by estimating the classification code of the input data by using the classification model. The classification model is a trained machine learning model trained to receive an input of data and estimate the classification code in the classification system of classification targets. As the classification model, a known document classification model or the like can be used. As the classification system, for example, a classification system used for a document classification task for business use can be used. The classification system may be a classification system applicable to a task of sequentially performing classification in conjunction with input of input data such as text data.

The code estimation unit 102 reads the classification model and inputs the input data to the read classification model. The classification model receives an input of the input data and outputs an estimation result of the classification code. The code estimation unit 102 acquires the classification code output by the classification model as the estimation code. The classification code includes a number, a symbol, a character string, and the like. The classification code may be read as a classification label.

The cluster space construction unit 103 classifies the classification code of the classification system into a plurality of clusters using the explanatory information of the classification code, and constructs a cluster space by embedded expression. The explanatory information includes, for example, an explanatory sentence and a supplementary sentence set for each classification code in the classification system. In the classification system used for a document classification task for business use, an explanatory sentence describing definition of each classification code and a supplementary sentence supplementing the explanatory sentence are generally prepared in advance. The cluster space is an embedding space of vocabularies constructed using the vocabularies extracted from the explanatory sentence and the supplementary sentence. For the construction of the cluster space, a known technique such as a (Sentence-) BERT model or an existing embedding model can be used. Further, the cluster space construction unit 103 classifies the classification code into a plurality of clusters by converting the explanatory information of the classification code into feature vectors of a fixed number of dimensions and clustering each feature vector. The number of clusters is set to a smaller than the number of the classification codes. As a result, a plurality of the classification codes having similar meanings can be classified into one cluster. The cluster space construction unit 103 transmits the constructed cluster space to the cluster space search unit 104.

The cluster space search unit 104 calculates a cluster similarity of the input data by using the cluster space. The cluster similarity is a similarity between the input data and the cluster. For example, the cluster space search unit 104 acquires the embedded expression of the input data, and calculates, for each cluster, the cluster similarity in a case where the embedded expression is arranged in the cluster space. At this time, the embedded expression of the input data is acquired using only some data including the latest token in the input data. Thereafter, the cluster space search unit 104 specifies a cluster having the largest cluster similarity as a similar cluster (hereinafter referred to as a similar cluster). The cluster space search unit 104 transmits identification information such as a cluster number and the cluster similarity to the output balancing unit 105 for the similar cluster.

The output balancing unit 105 adjusts the method of outputting the estimation code based on the cluster similarity of the similar cluster, and outputs the adjusted output method to the display unit. The estimation code is output to the display unit based on the adjusted output method. For example, the estimation code is displayed on the display unit based on the adjusted display method.

For example, in a case where the similar cluster does not change, the output balancing unit 105 makes the display of the estimation code less likely to change. Further, the output balancing unit 105 adjusts an appearance time, an appearance speed, a color of a character, a color of a background, or a size of a character in a case where the estimation code is displayed based on the cluster similarity. For example, the output balancing unit 105 adjusts a display effect of the estimation code to be displayed according to the cluster similarity, and adjusts a degree of emphasis of the estimation code according to the display effect. Hereinafter, the estimation code to be displayed is referred to as a display code. The output balancing unit 105 increases the display effect of the display code in a case where the cluster similarity is high, and decreases the display effect in a case where the similar cluster has changed. The characters of the display code is preferably enlarged in a case where the display effect is high, for example, and the characters of the display code is preferably reduced in a case where the display effect is low. Further, the color of the characters may be displayed dark in the case where the display effect is high, and the color of the characters may be displayed light in the case where the display effect is low.

Further, the output method may be adjusted according to an accuracy of the display code. For example, the color of the characters of the display code is preferably displayed dark in a case where the accuracy is high, and the color of the characters of the display code is preferably displayed light in a case where the accuracy is low.

Further, the output method may be adjusted according to the boundary weight of the token. For example, the timing of changing the display code is preferably delayed in a case where the boundary weight of the token is small, and the timing of changing the display code is preferably advanced in a case where the boundary weight of the token is large.

Next, an operation of pre-processing executed by the cluster space construction unit 103 of the input support apparatus 100 will be described.

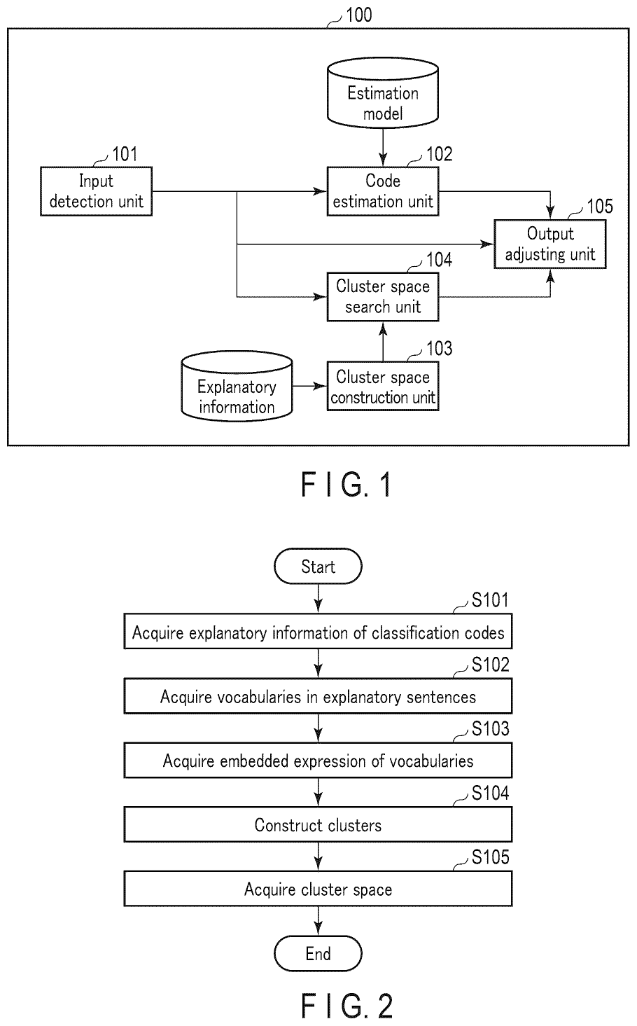

The pre-processing is processing of constructing the cluster space in advance as pre-preparation for outputting the estimation code for the input data. FIG. 2 is a flowchart illustrating an example of a procedure of pre-processing. Note that a processing procedure in each processing to be described below is merely an example, and each processing can be appropriately changed as much as possible. Further, with respect to the processing procedure to be described below, appropriate omission, replacement, and addition of steps are possible according to the embodiment.

Here, a case of supporting creation of a failure report document in a document classification task for business use will be described as an example. The input support apparatus 100 automatically estimates the code number of the industry predetermined classification code that needs to be written in the failure report document from hundreds of candidates in conjunction with the input of the character string from the user, and presents the estimated classification code to the user.

### Input Support Processing

### (Step S101)

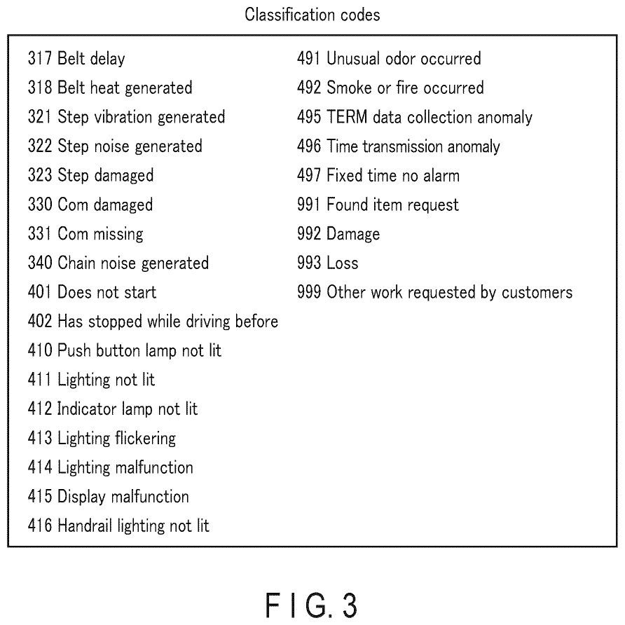

In the pre-processing, the cluster space construction unit 103 first acquires the explanatory information of the target classification system. FIG. 3 is a diagram illustrating a classification code table in the target classification system. In the classification system of FIG. 3, the explanatory sentence of the classification codes has differences such as belt, heat generation, and large or small slip. It is desirable that each classification code in the classification system is independent. However, in the definition of the classification code as illustrated in FIG. 3, there are similar classification codes, conflicting classification codes, and the like.

### (Step S102)

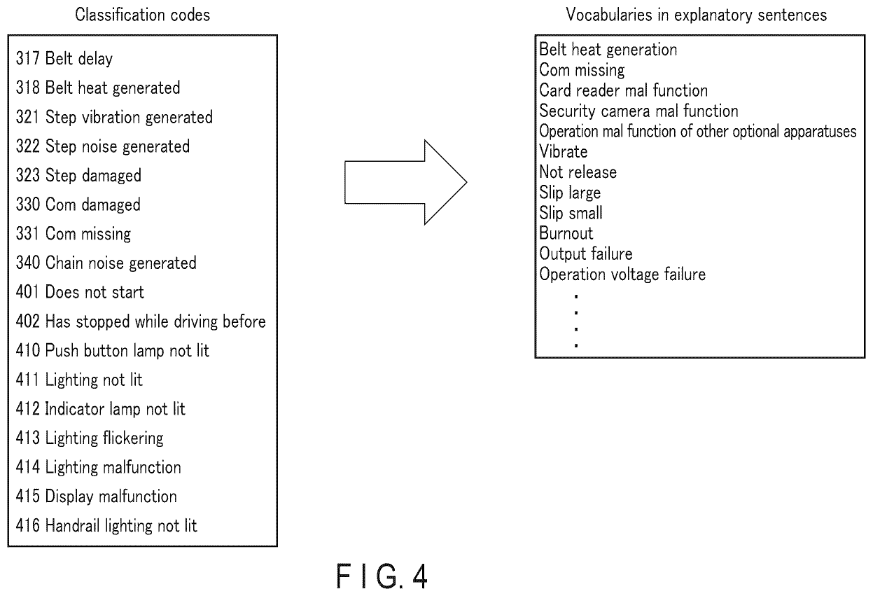

Next, the cluster space construction unit 103 performs a morpheme analysis for the explanatory sentence of the classification code and deletes unnecessary vocabularies such as particles, thereby acquiring the vocabularies in each classification code. FIG. 4 illustrates a result of extraction of the vocabularies in the explanatory sentences of the classification codes illustrated in FIG. 3.

### (Step S103)

Next, the cluster space construction unit 103 acquires the embedded expression of the vocabularies using the extracted vocabularies.

### (Step S104)

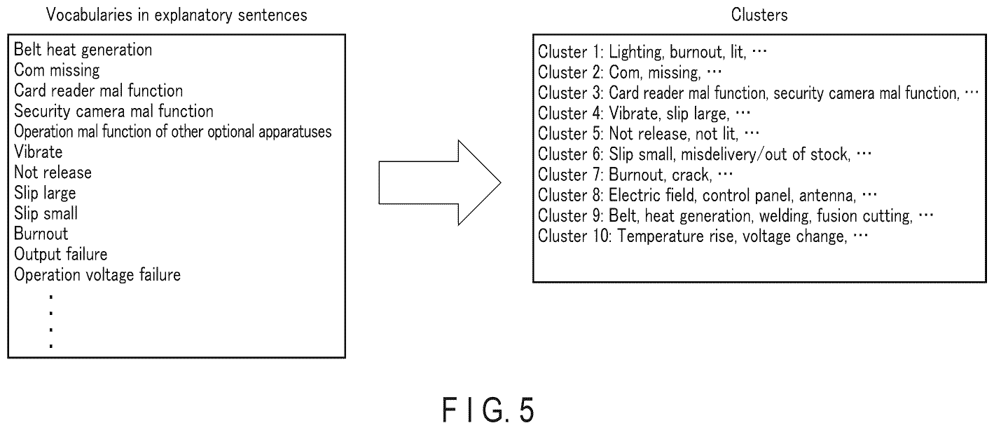

Next, the cluster space construction unit 103 vectorizes each vocabulary extracted from the explanatory sentence, acquires a feature vector of each vocabulary, and generates a cluster in which each vocabulary is classified according to the feature vector. FIG. 5 is a diagram illustrating a result of classifying the vocabularies illustrated in FIG. 4 into ten clusters. Each cluster includes vocabularies having close meanings. Cluster 1 in FIG. 5 includes similar vocabularies such as “belt heat generation”, “welding”, and “fusion cutting”. The number of clusters to be created is set to a number smaller than the number of classification codes.

### (Step S105)

Next, the cluster space construction unit 103 generates the embedding space of the vocabularies using the embedded expression of the vocabularies, and constructs the cluster space in which the cluster distributions to which the vocabularies belong are integrated into the embedding space of the vocabularies. At this time, the number of dimensions of the cluster space is set to an arbitrary number of dimensions according to an embedding model.

Next, an operation of input support processing executed by the input support apparatus 100 will be described.

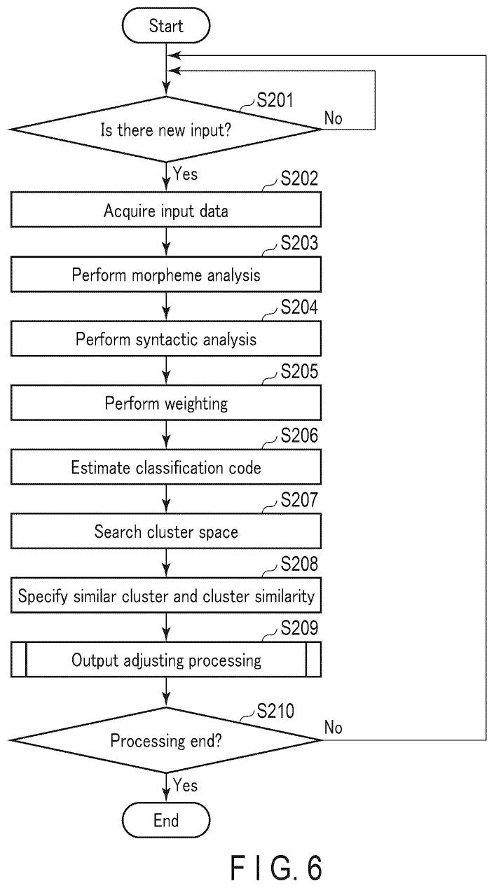

The input support processing is processing of sequentially acquiring the input data to be classified, inputting the acquired input data to the estimation model, and presenting the classification result output from the estimation model to the user. FIG. 6 is a flowchart illustrating an example of a procedure of the input support processing. Note that a processing procedure in each processing to be described below is merely an example, and each processing can be appropriately changed as much as possible. Further, with respect to the processing procedure to be described below, appropriate omission, replacement, and addition of steps are possible according to the embodiment.

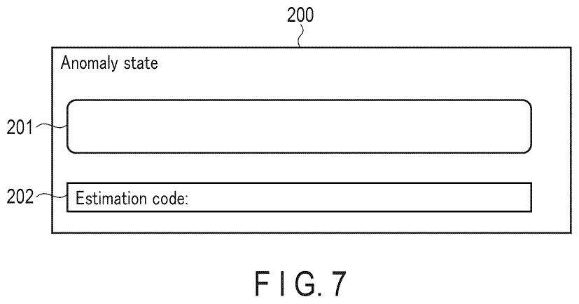

The input support processing is started in a state where an input screen for creating an anomaly report is displayed on the display unit. FIG. 7 is a diagram illustrating an example of an input screen 200 displayed on the display unit. The input screen 200 of FIG. 7 includes an information input unit 201 and an estimation code display unit 202. Information about an anomaly state input by the user is displayed on the information input unit 201. The estimation code display unit 202 displays the estimation code estimated using the character string input to the information input unit 201. Here, as an example, a case where the estimation code of the input sentence is displayed using the classification system illustrated in FIG. 3 and the clusters illustrated in FIG. 5 will be described.

### Input Support Processing

### (Step S201)

In the input support processing, first, the input detection unit 101 detects an input by the user and determines whether or not there is a new input by the user.

### (Step S202)

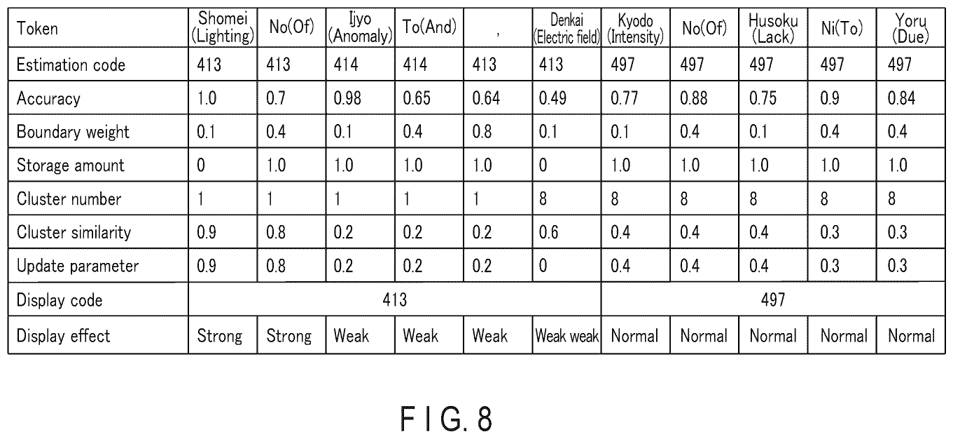

In a case where a new character string is input (Yes in step S201), the input detection unit 101 acquires the input sentence input to the information input unit 201 as the input data. At this time, the information input unit 201 acquires all the character strings included in the input sentence as the input data. Here, a case where a Japanese input sentence “Shomeinoijyoto, denkaikyodonohusokuniyoru” (a Japanese sentence meaning “Caused by lighting anomalies and a lack of electric field strength”) is input to the information input unit 201 will be described as an example. FIG. 8 is a diagram illustrating a processing result in a case where the Japanese input sentence “Shomeinoijyoto, denkaikyodonohusokuniyoru” is input, and the Japanese input sentence is divided into a plurality of tokens “Shomei” a Japanese word meaning “lighting”), “No” a Japanese word meaning “of”), “Ijyo” a Japanese word meaning “anomaly”), “To” a Japanese word meaning “and”), “Denkaikyodo” a Japanese word meaning “electric field intensity”), “No” a Japanese word meaning “of”), “Husoku” a Japanese word meaning “lack”), “Ni” a Japanese word meaning “by”), and “Yoru” a Japanese word meaning “caused”).

### (Step S203)

Next, the input detection unit 101 executes the morpheme analysis for the input sentence, detects the morpheme delimiter in the input sentence, and divides the input sentence into a plurality of tokens using the morpheme delimiter. Further, the input detection unit 101 specifies the part of speech of each token by the morpheme analysis.

### (Step S204)

Next, the input detection unit 101 executes the syntactic analysis for the input sentence and detects the syntax delimiter. At this time, the input detection unit 101 detects a punctuation mark or a change in a specific part of speech as the syntax delimiter.

### (Step S205)

Next, the input detection unit 101 performs weighting of each token using the syntax delimiter and determines the boundary weight of each token. At this time, for tokens input in the past, past data is read. In the example of FIG. 8, the boundary weight is set to “0.8” in a case where the token is a punctuation mark. Further, in a case where the part of speech is changed from a noun to a particle and the particle is changed to a different part of speech in the next token, the boundary weight of the token with the different part of speech is set to “0.4”. Further, the boundary weight of the token other than the above is set to “0.1”.

### (Step S206)

Next, the code estimation unit 102 estimates the classification code using the classification model, and acquires the estimation code and the accuracy of the token. At this time, the code estimation unit 102 reads the classification model, inputs the input sentence to the classification model, acquires the classification code and the accuracy output from the classification model, and stores the classification code and the accuracy in association with the latest token. Further, for the token input in the past, the estimation code and the accuracy created in the past are acquired.

### (Step S207)

Next, the cluster space search unit 104 searches the cluster space and specifies the position of the input sentence in the cluster space. At this time, the cluster space search unit 104 positions the input sentence at any point in the predefined cluster space. As the input sentence, some tokens including the latest token are used.

### (Step S208)

Next, the cluster space search unit 104 calculates the cluster similarity between the input sentence and each cluster by calculating the distance from the position indicating the input sentence to each cluster in the cluster space. Further, the cluster having the highest cluster similarity among the clusters is specified as the similar cluster.

Note that, in the example of FIG. 8, the estimation code is the estimation result of the estimation model trained using the training data in units of paragraphs, whereas the similar cluster is the estimation result using only some token strings sequentially input in the input sentence, and thus the timing at which the output result changes is different.

### (Step S209)

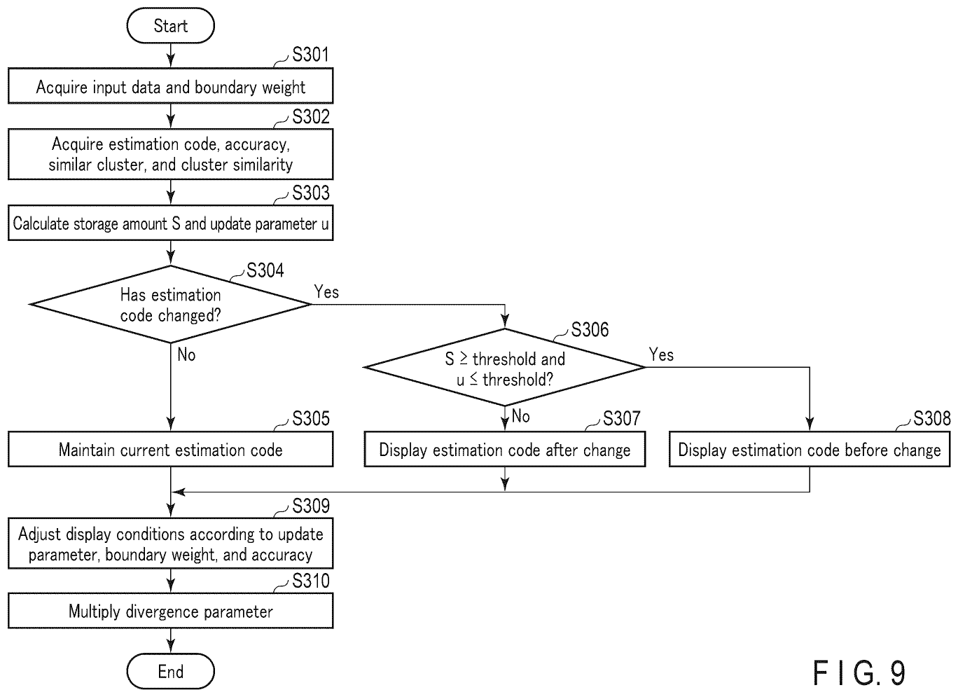

Next, the output balancing unit 105 executes output balancing processing. The output balancing processing is processing of balancing the method of outputting the estimation code based on the cluster similarity using the cluster space. FIG. 9 is a flowchart illustrating an example of a procedure of the output balancing processing. Note that a processing procedure in each processing to be described below is merely an example, and each processing can be appropriately changed as much as possible. Further, with respect to the processing procedure to be described below, appropriate omission, replacement, and addition of steps are possible according to the embodiment.

### (Step S301)

In the output balancing processing, the output balancing unit 105 first acquires each token included in the input sentence and the boundary weight of each token. At this time, the sequence information indicating an input order of the tokens is also acquired. For tokens input in the past, past data is read.

### (Step S302)

Next, the output balancing unit 105 acquires the estimation code, the accuracy, the cluster number of the similar cluster, and the cluster similarity of the similar cluster for each token. At this time, for tokens input in the past, past data is read.

### (Step S303)

Next, the output balancing unit 105 acquires a storage amount S and an update parameter u for each token. At this time, for tokens input in the past, past data is read. The storage amount S is an example of a first index, and the update parameter u is an example of a second index. The storage amount S is an index indicating a length in which the cluster number of the similar cluster does not change. The output balancing unit 105 calculates, as the storage amount S, an accumulated value of the cluster similarity from the time of change of the cluster number. At this time, for example, the output balancing unit 105 reads the storage amount S of the immediately preceding token and sums the read storage amount S with the cluster similarity of the latest token to calculate the storage amount S of the latest token. Further, in a case where the cluster number of the token to be calculated has been changed with respect to the cluster number of the immediately preceding token, the output balancing unit 105 sets the storage amount S to 0. Further, a maximum value is set to the storage amount S, and in a case where the storage amount S exceeds the maximum value, the storage amount S is converted into the value of the maximum value. In FIG. 8, “1.0” is set as the maximum value.

For example, in the token “electric field” in FIG. 8, since the cluster number has changed from “1” to “8”, the storage amount S becomes “0”. Further, since the cluster number is unchanged in the token “intensity”, the storage amount S is a value “1.0 (=0.4+0.6)” obtained by accumulating the cluster similarities from “electric field” with the change in the cluster number to “intensity”. Further, since the cluster number is unchanged in the token “of”, the storage amount S is “1.0” obtained by converting the cumulative value (1.4) of the cluster similarities from “electric field” to “of” in which the cluster number has changed into the maximum value.

Further, the output balancing unit 105 sets the update parameter u as the value of the cluster similarity in the case where the cluster number is unchanged, and sets the update parameter u to 0 in the case where the cluster number has changed. For example, in the token “electric field” in FIG. 8, since the cluster number has changed from “1”to “8”, the update parameter u is “0”. Further, since the cluster number is unchanged in the token “intensity”, the update parameter u is “0.4” of the cluster similarity.

Thereafter, the output balancing unit 105 determines the display code to be displayed by the processing of steps S304 to S308 described below.

### (Step S304)

The output balancing unit 105 determines whether or not the estimation code has changed from the immediately preceding token.

### (Step S305)

In the case where the estimation code is unchanged (No in step S304), the output balancing unit 105 sets the estimation code as an output code.

### (Step S306)

In a case where the estimation code has changed (Yes in step S304), the output balancing unit 105 compares each of the storage amount S and the update parameter u with a threshold, and determines which one of the estimation code before the change and the estimation code after the change is to be displayed. Here, the threshold for the storage amount S is “0.8”, and the threshold for the update parameter u is “0.3”. The output balancing unit 105 determines whether or not the storage amount S is 0.8 or more and the update parameter u is 0.3 or less.

### (Step S307)

In a case where at least one of the storage amount S or the update parameter u does not satisfy the above condition (No in step S306), that is, in a case where the storage amount S is smaller than the threshold (0.8), or in a case where the update parameter u is larger than the threshold (0.3), the output balancing unit 105 determines the estimation code before the change as the display code. In this case, the displayed estimation code does not change.

### (Step S308)

On the other hand, in a case where both the storage amount S and the update parameter u satisfy the above conditions (Yes in step S306), that is, in the case where the storage amount S is the threshold (0.8) or more and the update parameter u is the threshold (0.3) or less, the output balancing unit 105 determines the estimation code after the change as the display code. In this case, the displayed estimation code changes.

### (Step S309)

The output balancing unit 105 adjusts a display condition of the display code determined in the above processing according to the update parameter u, the boundary weight, and the accuracy. At this time, the output balancing unit 105 sets the display effect of the display code in each token according to the update parameter u. In the example of FIG. 8, four stages of “weak weak”, “weak”, “normal”, and “strong” are set as the display effect, and the display effect becomes higher in the order of “weak weak”, “weak”, “normal”, and “strong”. Here, the display effect is set to “strong” in a case where the update parameter u is 0.8 or more, the display effect is set to “strong” in a case where the update parameter u is 0.3 or more, the display effect is set to “normal” in a case where the update parameter u is 0.3 or more and less than 0.8, the display effect is set to “weak” in a case where the update parameter u is 0.1 or more and less than 0.3, and the display effect is set to “weak weak” in a case where the update parameter u is less than 0.1.

The output balancing unit 105 adjusts the display condition of the token according to the display effect. At this time, the output balancing unit 105 sets the display condition such that the estimation code is displayed in a more emphasized manner as the display effect is higher. For example, the characters of the display code is preferably enlarged in a case where the display effect is high, and the characters of the display code is preferably reduced in a case where the display effect is low. Further, the color of the characters may be displayed dark in the case where the display effect is high, and the color of the characters may be displayed light in the case where the display effect is low.

Thereafter, the output balancing unit 105 outputs the display code and the adjusted display condition to the display unit. The display unit displays the display code according to the adjusted display condition.

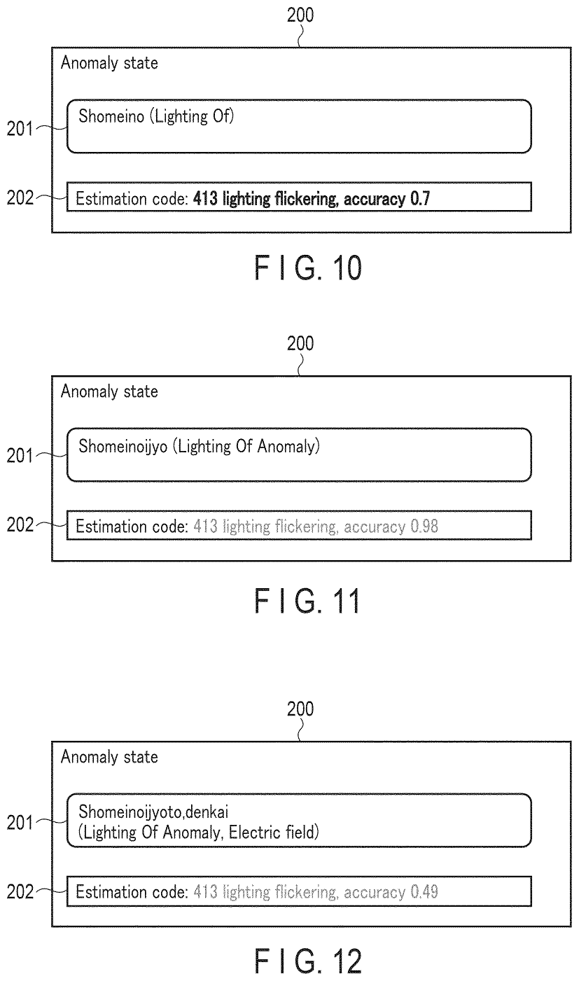

The following is a specific example using Japanese input sentence. For example, at the timing at which the Japanese input sentence “Shomeino” is input, and the Japanese input sentence is divided into a plurality of tokens “Shomei (a token meaning “Lighting” in Japanese)”, and “No (a token meaning “Of” in Japanese)”, the display code is “413” because the estimation code is unchanged from “413” as illustrated in FIG. 8. Further, since the update parameter u is 0.8, the display effect is set to “strong”, and the estimation code and the accuracy displayed on the estimation code display unit 202 are displayed with the maximum degree of emphasis. In the example of FIG. 10, the characters are displayed in bold.

Further, at the timing at which the Japanese input sentence “Shomeinoijyo” is input, and the Japanese input sentence is divided into a plurality of tokens “Shomei (a token meaning “Lighting” in Japanese)”, “No (a token meaning “Of” in Japanese)” and “Ijyo (a token meaning “Anomaly” in Japanese)”, the estimation code has changed from “413” to “414” as illustrated in FIG. 8, but since the storage amount S is 1.0 that is the threshold (0.8) or more and the update parameter u is 0.2 that is the threshold (0.3) or less, the display code “413” that is the estimation code before the change is selected and displayed on the estimation code display unit 202 as illustrated in FIG. 11. Further, since the update parameter u is 0.2, the display effect is set to “weak”, and the estimation code and the accuracy displayed on the estimation code display unit 202 are displayed with the third degree of emphasis from the top, as illustrated in FIG. 11. In the example of FIG. 11, the characters are displayed light.

Further, at the timing at which the Japanese input sentence “Shomeinoijyoto, denkai” is input, and the Japanese input sentence is divided into a plurality of tokens “Shomei (a token meaning “Lighting” in Japanese)”, “No (a token meaning “Of” in Japanese)” “Ijyo (a token meaning “Anomaly” in Japanese)”, “To (a token meaning “And” in Japanese)”, “,”, and “Denkai (a token meaning “Electric field” in Japanese)”, the estimation code is unchanged from “413” as illustrated in FIG. 8, and thus the display code is “413”. Further, since the cluster similarity has changed from “1” to “8”, and the update parameter u is 0, the display effect is set to “weak weak”, and the estimation code and the accuracy displayed on the estimation code display unit 202 are displayed with the lowest degree of emphasis, as illustrated in FIG. 12. In the example of FIG. 12, the characters are displayed light in a small size.

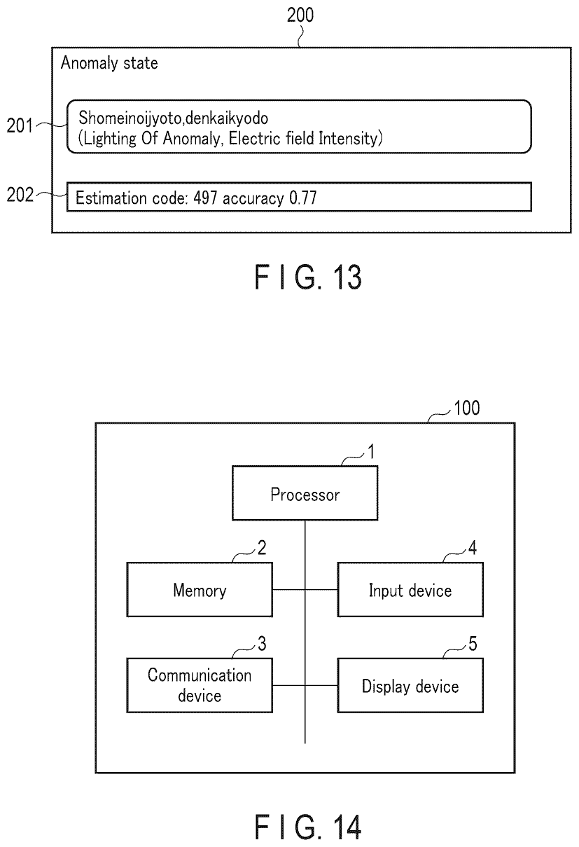

Further, at the timing at which the Japanese input sentence “Shomeinoijyoto, denkaikyodo” is input, and the Japanese input sentence is divided into a plurality of tokens “Shomei (a token meaning “Lighting” in Japanese)”, “No (a token meaning “Of” in Japanese)” “Ijyo (a token meaning “Anomaly” in Japanese)”, “To (a token meaning “And” in Japanese)”, “,”, “Denkai (a token meaning “Electric field” in Japanese)”, and “Kyodo (a token meaning “Intensity” in Japanese)”, the estimation code has changed from “413” to “497” as illustrated in FIG. 8, and the storage amount S is 1.0 that is the threshold (0.8) or more and the update parameter u is 0.4 that is larger than the threshold (0.3), and thus the display code “497” that is the estimation code after the change is selected and displayed on the estimation code display unit 202 as illustrated in FIG. 13. Further, since the update parameter u is 0.4, the display effect is set to “normal”, and the estimation code and the accuracy displayed on the estimation code display unit 202 are displayed with the second degree of emphasis from the top. Furthermore, the timing at which the display changes from “413” to “497” may be set to the second stage from the top. In the example of FIG. 13, the characters are displayed under the normal condition.

Further, the display condition may be adjusted according to the accuracy of the display code. For example, the color of the characters may be displayed dark in the case where the accuracy is high, and the color of the characters may be displayed light in the case where the accuracy is low. Further, the timing at which the display code changes or an effect time may be adjusted according to the boundary weight. For example, the timing of updating the display code may be delayed in the case where the boundary weight is small, and the timing of updating the display code may be advanced in the case where the boundary weight is large. Furthermore, the time to apply the display effect may be adjusted according to the accuracy or the boundary weight.

Note that each parameter used in the processing from step S301 to step S309 is stored as the parameter of each token, and is read and used in the processing in a case where the next character string is input.

### (Step S310)

Next, the output balancing unit 105 multiplies the storage amount S by a divergence parameter. The divergence parameter is set to a value smaller than 1 (for example, 0.9). The storage amount S is stored in a state of being decreased by the divergence parameter. In a case where the next character string is input, the storage amount S of the latest token is calculated by adding the cluster similarity of the latest token to the read storage amount S. Thereafter, after the output balancing processing, the storage amount S of the latest token is further multiplied by the divergence parameter and stored. By repeating the above processing every time the new character string is input, an influence on the storage amount S, of the character string input further in the past, decreases. Since the longer the input sentence, the higher the possibility that context changes, it is preferable to reduce the influence on the storage amount, of the character string input in the past, by using the divergence parameter as described above. Note that, in the example of FIG. 8, the calculation result with the divergence parameter is not reflected for simplification of description. Further, as described above, the maximum value is set to the storage amount S, and in the case where the storage amount S exceeds the maximum value, the storage amount S is converted into the value of the maximum value. As a result, even in a case where the storage amount S is too large, the influence on the storage amount, of the character string input in the past, can be appropriately reduced.

### (Step S210)

In a case where the processing of step S310 ends, the output balancing unit 105 terminates the output balancing processing of step S209. Thereafter, the input support apparatus 100 determines whether or not to terminate the input support processing. For example, in a case where the user has performed an operation to terminate the input of the input sentence (Yes in step S210), the input support apparatus 100 terminates the input support processing. In a case where the input support processing is not terminated (No in step S210), the processing returns to step S201, and the processing from step S201 to step S209 is repeatedly executed each time new characters are input by the user.

Next, effects of the configuration and operation of the input support apparatus 100 according to the present embodiment will be described.

The input support apparatus 100 according to the present embodiment is an apparatus that presents the estimation code to the user in conjunction with a sequential input of the input data desired to be classified, and includes the input detection unit 101, the code estimation unit 102, the cluster space construction unit 103, the cluster space search unit 104, and the output balancing unit 105. The input detection unit 101 detects the division position in the input data, and divides the input data into the plurality of division units. The code estimation unit 102 acquires the estimation code obtained by estimating the classification code of the input data by using the estimation model. The cluster space construction unit 103 classifies the classification code of the classification system into the plurality of clusters using the explanatory information of the classification code, and constructs the cluster space by embedded expression. The cluster space search unit 104 calculates the cluster similarity between the input data and the cluster by using the cluster space. The output balancing unit 105 adjusts the method of outputting the estimation code based on the cluster similarity.

For example, in a case where a period during which the similar cluster does not change is long, the output balancing unit 105 makes the display code less likely to change. As a result, by balancing the change in the display code using the similarity with the cluster in the vocabulary space using the explanatory sentence of the classification code, it is possible to impart elasticity or viscosity to variability of the display code.

The output balancing unit 105 of the present embodiment makes the display code less likely to change in the case where the storage amount is large. The storage amount is accumulated and increases in the case where the similar cluster does not change. Therefore, the longer the period during which the similar cluster does not change, the larger the storage amount, and the display code is less likely to change. As a result, even in the case where the estimation code has changed, the display code is less likely to change in a case where the change is small enough to keep the similar cluster from changing. That is, the frequency of the change in the display code can be suppressed in the case where the similar cluster does not change. Meanwhile, immediately after the similar cluster has changed, the storage amount decreases, and the change in the display code is not suppressed. Therefore, the display code can be appropriately changed in a case where a large change occurs to such an extent that the similar cluster changes.

Further, the output balancing unit 105 adjusts the appearance time, the appearance speed, the color of a character, the color of the background, or the size of a character in a case where the estimation code is displayed based on the update parameter calculated using the cluster similarity. For example, the output balancing unit 105 increases the display effect of the display code in the case where the update parameter is high, and increases the display effect of the display code in the case where the cluster similarity is high. As a result, the estimation code is displayed in an emphasized manner in the case where the cluster similarity is high. In this case, the user can determine that reliability of the displayed estimation code is high. Further, in the case where the similar cluster has changed, the output balancing unit 105 sets the update parameter to 0 to reduce the display effect of the display code. At the timing at which the similar cluster has changed, the reliability of the estimation code decreases. By reducing the display effect of the display code in the case where the similar cluster has changed, the user can determine that the reliability of the displayed estimation code is low.

Further, the output balancing unit 105 adjusts the output method using a clustering result using a part of the input sentence in order to detect a local similarity that is not used in the estimation model. For example, the output balancing unit 105 constructs the embedding space based on the vocabularies in the explanatory sentence, using the explanatory sentence describing the classification system, clusters the vocabularies of the explanatory sentence, Then, it searches the embedding space using the embedded expression of the sequentially input sentence to specify the similar cluster and the cluster similarity. Thereafter, by balancing the display timing, the display speed, the color, the font, and the like of the estimation code to be displayed to the user according to the similar cluster and the cluster similarity, it is possible to change the visual effect of the display code and present an output that satisfies the user. For example, the output balancing unit 105 increases the display effect of the display code in the case where the cluster similarity is high, and decreases the display effect of the display code in the case where the cluster similarity is low or in the case where the similar cluster has changed.

In the sequential display of the estimation code using the estimation model, since the input data is a partial character string, the classification accuracy may be deteriorated. According to the above configuration, the method of changing the display code reflecting the change in the similar cluster and the display effect reflecting the cluster similarity are obtained. Therefore, it is possible to present the estimation code by the output method with a higher sense of satisfaction for the user than a case where the estimation code output from the estimation model is displayed as it is, and it is possible to improve usability of the input support apparatus 100. Furthermore, it is possible to present the output at more appropriate and detailed timing even for a user's partial input.

Further, the display of the estimated code may be adjusted according to the accuracy of the estimation code or the morpheme analysis result or the syntax delimiter in the input character string. For example, by setting the boundary weight according to a grammar delimiter or the syntax delimiter and balancing the output according to the boundary weight, it is possible to generate the output that satisfies the user. In this manner, by displaying the classification code in an emphasized manner at a grammatical boundary or a sentence structural boundary, it is possible to update the display code at the timing that satisfies the user. This makes it possible to more closely associate local context of the input sentence with the classification system.

As described above, by considering consistency between the estimation code and the clustering result and a change in the clustering result, even in a case where the classification model used in batch processing is applied to the sequential automatic classification processing, it is possible to output the estimation result that satisfies the user.

Further, in a case where a code as assumed by the user is not output even if “noise” is input, the user may output an assumed code by rewriting the “noise” to “anomaly sound” or the like. As described above, trial and error on the user side may be required, and the usability of an automatic estimation function may be deteriorated. To solve the above problem, the classification code to be selected as the estimation code may be changed according to the cluster similarity. For example, in a case where the classification model that outputs a plurality of classification codes in descending order of accuracy is used, the classification code to be adopted as the estimation code may be changed according to the magnitude of the cluster similarity. In this case, in a case where the cluster similarity satisfies a predetermined condition, the classification code having the second highest accuracy may be used as the estimation code instead of the classification code having the highest accuracy.

Note that the input data may be an image data group including the sequence information. For example, moving image data constituted by an image data group can be used as the input data. As the division unit, for example, an image unit constituting the moving image data, a part of a partial image, or a part of a stroke can be used. For example, the input support apparatus 100 sequentially acquires the image data included in the moving image data along a time series, predicts and outputs the classification code in the classification system each time the image data is acquired.

Even in the case where the input data is image data, it is possible to display the estimation code by a method highly satisfactory to the user by using the cluster space constructed using the explanatory information of the classification system and balancing the method of outputting the estimation code according to the similar cluster and the cluster similarity.

### Application

FIG. 14 is a block diagram illustrating a hardware configuration of the input support apparatus 100 according to an application. The application is a specific example of the embodiment and each modification, and the input support apparatus 100 is implemented by a computer.

The input support apparatus 100 includes, as hardware, a processor 1, a memory 2, a communication device 3, an input device 4, and a display device 5. The processor 1 communicates with the memory 2, the communication device 3, the input device 4, and the display device 5 via a bus. That is, the input support apparatus 100 of the present embodiment is implemented by a computer having such a hardware configuration.

The processor 1 is an integrated circuit that controls the entire operation of the input support apparatus 100. For example, the processor 1 includes a central processing unit (CPU), a graphics processing unit (GPU), a digital signal processor (DSP) and/or a floating-point unit (FPU).

The processor 1 may include an internal memory or an I/O interface. The processor 1 executes various types of processing by interpreting and calculating a program stored in advance in the memory 2. Note that a part or the whole of the processor 1 may be implemented by hardware such as an application specific integrated circuit (ASIC) or a field programmable gate array (FPGA).

The memory 2 is a storage medium including, for example, a read only memory (ROM), a random access memory (RAM), and an auxiliary storage apparatus. The ROM is a non-volatile memory that stores various data. For example, the ROM stores data, setting values, and the like used in a case where the processor 1 executes the various types of processing. The ROM may have a non-transitory computer-readable storage medium that stores the program executed by the processor 1. The RAM is a volatile memory used for reading and writing data. The RAM temporarily stores data to be used in a case where the processor 1 executes the various types of processing. The RAM provides a work area for the processor 1. The auxiliary storage apparatus is a non-volatile memory that stores various data. For example, the auxiliary storage apparatus stores data and setting values used in a case where the processor 1 executes the various types of processing, data generated in the various types of processing by the processor 1, and the like. The auxiliary storage apparatus includes a hard disk drive (HDD), a solid state drive (SSD), an integrated circuit storage apparatus, and the like. Note that the auxiliary storage apparatus may include a non-transitory computer-readable storage medium that stores the program executed by the processor 1.

The communication device 3 includes a communication interface such as a network interface card (NIC) for performing data communication with various devices connected to the input support apparatus 100 via the network. Note that an operation signal may be supplied from a computer connected via the communication device 3 or an input unit included in the computer, or various data may be displayed on a display unit or the like included in the computer connected via the communication device 3.

The input support apparatus 100 does not need to include all of the memory 2, the communication device 3, the input device 4, and the display device 5. Part of the memory 2 and the communication device 3 may not be provided as necessary. The input support apparatus 100 may be provided with any additional hardware device useful for executing the processing according to the present embodiment. The input support apparatus 100 does not need to be physically configured by one computer, and may be configured by a computer system including a plurality of computers communicably connected via a wire, a network line, or the like. Assignment of the series of processing according to the present embodiment to the plurality of processors 1 respectively mounted on a plurality of computers can be arbitrarily set. All the processors 1 may execute all pieces of the processing in parallel, or specific processing may be assigned to one or some of the processors 1 and the series of processing according to the present embodiment may be executed as the entire computer system.

Thus, according to the present embodiment, it is possible to provide the input support apparatus, the method, and the program with the improved method of displaying the classification code in the input support using the automatic classification function of the sequential processing method.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An input support apparatus comprising: processing circuitry, wherein
the processing circuitry is configured to
detect a division position in input data and divide the input data into a plurality of division units,
acquire an estimation code by estimating a classification code of the input data by using a classification model that receives an input of data and estimates the classification code in a classification system,
classify the classification code into a plurality of clusters using explanatory information of the classification code and construct a cluster space by embedded expression,
calculate a cluster similarity between the input data and the cluster by using the cluster space, and
adjust a method of outputting the estimation code based on the cluster similarity.

2. The input support apparatus according to claim 1, wherein
the input data is an input sentence in a sentence format, and
the processing circuitry is configured to divide the input sentence into the division units by executing a morpheme analysis and a syntactic analysis for the input sentence, and determine a boundary weight of the division unit.

3. The input support apparatus according to claim 1, wherein
the explanatory information includes a vocabulary in an explanatory sentence of the classification code.

4. The input support apparatus according to claim 1, wherein
the division unit is a token, and
the processing circuitry is configured to estimate the classification code of the input data for each token by inputting the token into the classification model.

5. The input support apparatus according to claim 1, wherein
the processing circuitry is configured to adjust the appearance time, an appearance speed, a color of a character, a color of a background, or a size of a character in a case where the estimation code is displayed based on the cluster similarity.

6. The input support apparatus according to claim 1, wherein
the processing circuitry is configured to
determine a similar cluster based on the cluster similarity,
calculate a first index that is a cumulative value of the cluster similarity from a time of change in the similar cluster in a case where the similar cluster does not change, and is 0 in a case where the similar cluster has changed,
calculate a second index that becomes a value of the cluster similarity in the case where the similar cluster does not change, and becomes 0 in the case where the similar cluster has changed,
output an estimation result after change in a case where the estimation code has changed, and the first index is small or the second index is high, and
output an estimation result before change in a case where the estimation code has changed, and the first index is high or the second index is small.

7. The input support apparatus according to claim 6, wherein
the processing circuitry is configured to increase a display effect of the estimation code in the case where the second index is high and decrease the display effect in the case where the second index has changed.

8. A method comprising:
detecting a division position in input data and dividing the input data into a plurality of division units;
acquiring an estimation code by estimating a classification code of the input data by using a classification model that receives an input of data and estimates the classification code in a classification system;
classifying the classification code into a plurality of clusters using explanatory information of the classification code and constructing a cluster space by embedded expression;
calculating a cluster similarity between the input data and the cluster by using the cluster space;
outputting an estimation result indicating an estimation result of the classification code by the classification model; and
balancing a method of outputting the estimation code based on the cluster similarity.

9. A non-transitory computer-readable storage medium storing a program for causing a computer to execute:
a function to detect a division position in input data and divide the input data into a plurality of division units;
a function to acquire an estimation code by estimating a classification code of the input data by using a classification model that receives an input of data and estimates the classification code in a classification system;
a function to classify the classification code into a plurality of clusters using explanatory information of the classification code and construct a cluster space by embedded expression;
a function to calculate a cluster similarity between the input data and the cluster by using the cluster space;
a function to output an estimation result indicating an estimation result of the classification code by the classification model; and
a function to adjust a method of outputting the estimation code based on the cluster similarity.
